(19) United States
(12) Patent Application Publication
(10) Pub. No.: US 2018/0061104 A1
(43) Pub. Date: Mar. 1, 2018

(54) SYSTEMS AND METHODS FOR DISPLAYING A CONTROL SCHEME OVER VIRTUAL REALITY CONTENT

(71) Applicant: Fighter Base Publishing Inc., Scottsdale, AZ (US)

(72) Inventors: Mark Vange, Scottsdale, AZ (US); Marc Lutz, Scottsdale, AZ (US)

(21) Appl. No.: 15/681,133

(22) Filed: Aug. 18, 2017

Related U.S. Application Data
(60) Provisional application No. 62/381,710, filed on Aug. 31, 2016.

(51) Int. Cl. G06T 11/60; G06F 3/0482; G06F 3/147

(52) U.S. Cl. CPC G06T 11/60; G06F 3/04847; G06F 3/147; G06F 3/0482

(57) ABSTRACT

Systems and methods for displaying a control scheme according to various aspects of the present technology include a generating and displaying a control scheme over interactive content displayed on a personal display headset. In one embodiment, the control scheme is superimposed over the interactive content displayed on a headset at the same time the control scheme is active on a secondary control device such as a tablet or smartphone. The secondary control device allows the user to interact with the interactive content as part of a virtual or augmented reality experience. Inputs made to the secondary control device are shown on the superimposed control scheme to allow the user to see if they are touching the secondary control device in the proper location to interact with the interactive content.

### CROSS-REFERENCES TO RELATED APPLICATIONS

This application claims the benefit of U.S. Provisional Patent Application No. 62/381,710, filed Aug. 31, 2016, and incorporates the disclosure of the application by reference.

### BACKGROUND OF INVENTION

While using a virtual reality (VR) headset, a user's field of vision is typically reduced to only what is displayed by the VR headset to improve the immersion experience. For example, if a user were to utilize a VR headset to play a game, the user will only be able to see the game content while wearing the VR headset. In other words, the user is unable to see their surroundings, including other people and objects while wearing the VR headset.

In some cases, a game played on a VR headset may utilize additional controllers. The controllers may be adapted to fit the particular game. For example, in a first-person shooter game, the controller may be adapted to resemble a weapon. In some cases, a gamepad with a controller and physical button layout may be adapted to operate with the VR headset in playing a game. The gamepad may comprise a physical button layout such that a user can “feel” which button they are pressing.

In some cases, a generic programmable electronic screen (cell phone, tablet, etc.) may be utilized as the game controller. A control scheme layout may be displayed on the electronic screen such that the user is able to operate the electronic screen to play the game. However, in the case of a VR headset, the user is unable to perceive the button layout because the viewer is limited to viewing only what is displayed by the VR headset. In a traditional physical controller, the buttons can be “felt,” which is not capable in the VR setting utilizing a smooth display screen. Augmented Reality (AR) headsets may provide more external awareness in connection with interactive content but may be limited by factors such as field of view and focal point differences from taking full advantage of handheld controllers.

### SUMMARY OF THE INVENTION

Systems and methods for displaying a control scheme according to various aspects of the present technology include a generating and displaying a control scheme over interactive content displayed on a personal display headset. In one embodiment, the control scheme is superimposed over the interactive content displayed on a headset at the same time the control scheme is active on a secondary control device such as a tablet or smartphone. The secondary control device allows the user to interact with the interactive content as part of a virtual or augmented reality experience. Inputs made to the secondary control device are shown on the superimposed control scheme to allow the user to see if they are touching the secondary control device in the proper location to interact with the interactive content.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates an overview of the display system in accordance with an exemplary embodiment of the present technology;

FIG. 2 representatively illustrates a first electronic device configured to operate in conjunction with the display system in accordance with an exemplary embodiment of the present technology;

FIG. 3A representatively illustrates a headset in accordance with an exemplary embodiment of the present technology;

FIG. 3B representatively illustrates the headset displaying virtual content in accordance with an exemplary embodiment of the present technology;

FIG. 3C representatively illustrates a control scheme superimposed on the virtual content displayed on the headset in accordance with an exemplary embodiment of the present technology; and

FIG. 4 representatively illustrates a flow chart of the display system.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of portable computing devices, display systems, communication protocols, networks, software/firmware, and the like. In addition, the present technology may be practiced in conjunction with any number of electronic devices and communication networks, and the system described is merely one exemplary application for the technology.

Systems and methods for displaying secondary content according to various aspects of the present technology may operate in conjunction with any suitable portable electronic device and communication network. Various representative implementations of the present technology may be applied to any system for communicating information/data between two electronic devices.

Now referring to FIG. 1, in one embodiment, the display system 100 may comprise a control device 101 and a personal visual display device 103 configured to exchange data over a communication network 102. The personal visual display device 103 may be configured to display interactive content to a user, and the control device 101 may be configured to allow the user to have at least some functional or interactive control over the content being displayed on the personal visual display device 103.

The communication network 102 allows the control device 101 to communicate with the personal visual display device 103. The communication network 102 may comprise any suitable communication system incorporating wired or wireless technologies. For example, the communication network 102 may be established by physically linking the control device 101 to the personal visual display device 103 using a communication cable such as a coaxial, twisted pair, or optical fiber. In another example, the communication network 102 may be established using wireless technologies such as WIFI, Bluetooth®, cellular, radio frequencies, and/or the like. The wireless communication network 102 may be configured with sufficient bandwidth to facilitate the transmission of various types of data formats, including both audio and video information and/or data.

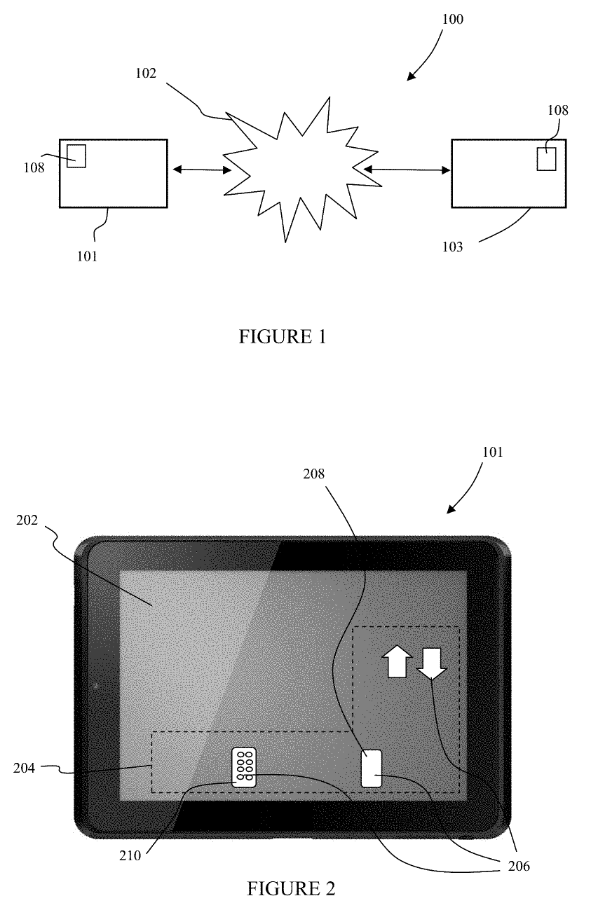

Now referring to FIG. 2, the control device 101 may comprise any suitable system or device configured to receive user inputs corresponding to a control scheme 204. The control scheme 204 may be presented in any suitable manner to allow the user to interact with the control scheme 204. In one embodiment, the control scheme 204 may comprise a plurality of options displayed on the electronic display 202 of the control device 101 such that the user can touch a desired option to achieve a desired result. For example, the control device 101 may comprise a game controller, a smartphone, a tablet, watch, or the like suitably configured to house the electronic display 202. The electronic display 202 may comprise a touchscreen configured to display the control scheme 204 and any additional information or data such a graphical user interface (GUI). The electronic display 202 may be suitably configured to present the control scheme 204 to the user and to receive control inputs from the user.

In a second embodiment, the control device 101 may be configured to receive input commands corresponding to the control scheme 204 without displaying a physical layout of the control scheme 204 to the user. For example, the control device 101 may comprise a touch-sensitive device without display capabilities, such as touch pad, smart cloth, motion sensing device, or the control device 101 may utilize the electronic display 202 as a touch pad rather than as a physical display. The touch-sensitive device may comprise any suitable system configured to determine where the control inputs were received on the touch-sensitive device. For example, the touch-sensitive device may comprise a touch-sensitive area configured to utilize an X-Y coordinate system to determine the location within the touch-sensitive area that received the user input. The touch-sensitive device may be configured to identify where the user has touched the touch-sensitive area relative to the control scheme 204 for the content and communicate that input to the personal visual display device 103.

The control device 101 may further comprise a plurality of physical controls. The plurality of physical controls may be configured to receive an input from a user and/or another device. The physical controls may comprise a plurality of buttons, dials, switches, knobs, sliders, and/or the like disposed on the control device 101 in various locations. Some of the physical controls may be disposed on the same surface of the control device 101 as the electronic display 202 while others may be disposed along the outer perimeter of the electronic display 202. The physical controls may also be disposed along the side of the control device 101, on a back surface of the control device 101, and/or anywhere on or within the control device 101.

The control device 101 may be further configured to sense/receive control inputs from other components integrated into the control device 101 such as a microphone and/or a camera. The microphone may comprise any suitable system or device configured to receive audio inputs from the user that may correspond to voice commands from the user for interacting with the content that is being displayed on the personal visual display device 103. Similarly, the camera may comprise any suitable system or device configured to receive visual information from the user such as physical actions/gestures performed by the user that allow the user to interact with the content that is being displayed on the personal visual display device 103.

The control device 101 may also be configured with any suitable system or device to provide tactile feedback to the user. For example, the control device 101 may comprise a vibration unit (not shown) configured to produce a vibration in the control device 101 in response to receiving a user input or to a signal from the personal visual display device 103. The tactile feedback may relate to any suitable criteria such as the displayed content on the personal visual display device 103, an indication that the user did not touch the control device 101 in the proper location to provide an input, or the like.

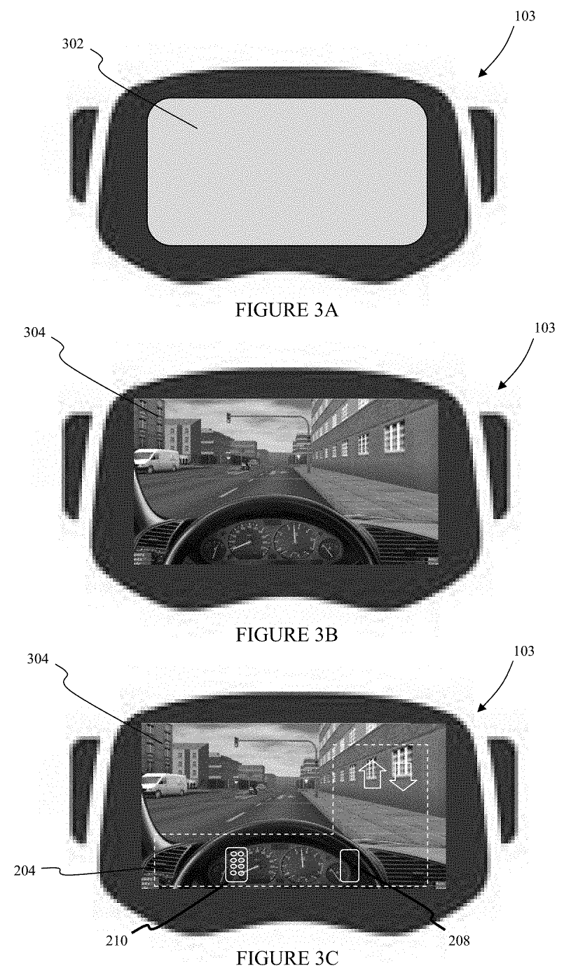

Now referring to FIGS. 3A, 3B, and 3C, the personal visual display device 103 may comprise any suitable system or device configured to provide the user an interactive viewing experience. The personal visual display device 103 may be configured to provide two-dimensional content as well as three-dimensional content to the user. The content may comprise static and/or interactive (dynamic) content. In one embodiment, the personal visual display device 103 may comprise a wearable electronic device such as: a virtual, augmented, or holographic headset device configured to communicate with the control device 101 over the communication network 102.

In one embodiment, the personal visual display device 103 may comprise an interactive display screen 302 configured to display interactive content 304 to the user. The interactive display screen 302 may comprise any suitable system or device configured to provide content to the user and/or receive input provided by the user and/or another system. For example, the interactive display screen 302 may comprise a LCD or LED screen configured to display VR content to the user.

The personal visual display device 103 may also comprise additional components to assist the user in viewing and/or interacting with the interactive content 304. For example, the personal visual display device 103 may comprise audio components, such as headphones or earbuds, and/or tactile feedback components.

Referring now to FIGS. 2 and 3B, the electronic display 202 of the control device 101 may be configured to display the control scheme 204 and/or a visual indication of where the sensed control inputs appear relative to the control scheme 204. The control scheme 204 may comprise a plurality of selectable options 206 corresponding to control functions for the interactive content 304 that is being displayed by the personal visual display device 103. The control scheme 204 may be selectively displayed and/or presented to the user in response to a display prompt. For example, after establishing a communication link between the control device 101 and the personal visual display device 103, either the control device 101 and/or the personal visual display device 103 may be configured to receive a display prompt or otherwise be instructed to display the control scheme 204.

The control scheme 204 may be controlled by a control system 108 configured to present and facilitate communication between the control device 101 and the personal visual display device 102 to allow the user to control, adjust, manipulate, and/or otherwise interact with the interactive content 304. For example, in one embodiment, the control scheme 204 may correspond to a video and be configured to display options to the user such as: play, stop, rewind, fast-forward, and the like. In another example, the control scheme 204 may comprise one or more control options corresponding to an interactive video game or other virtual reality content.

The control scheme 204 may comprise any suitable design, layout, and/or interface. A control scheme 204 layout may be configured to change depending on the interactive content 304 being displayed by the personal visual display device 103. The control scheme 204 layout may comprise predetermined layouts or may be customized by the user. For example, a first control scheme layout may be based on an application that performs audio/video playback to allow the user to control the audio/video content. A second control scheme layout may be generated to allow the user to operate an interactive video game or virtual reality experience. The control system 108 may allow the user to create a custom control scheme layout according to their desired preferences. The custom control scheme layout may be stored on a memory device located in the control device 101, the personal visual display device 103, or on a remote storage server (not shown).

Now referring to FIGS. 2 and 3C, the display system 100 may be configured to superimpose at least a portion of the control scheme 204 onto the interactive content 304 displayed by the personal visual display device 103 to communicate to the user whether they are interacting with the control scheme 204 on the control device 101 properly. Superimposing the control scheme 204 may comprise displaying the at least a portion of the control scheme 204 simultaneously with the interactive content 304 and may include mapping one or more of the plurality of selectable options 206 to the personal visual display device 103 in a manner that allows the user to associate the position of the selectable options 206 shown on the personal visual display device 103 with their location on the control device 101.

In one embodiment, the interactive content 304 may comprise an interactive video game and the plurality of selectable options 206 may comprise options that are configured to allow the user to interact with the video game. For example, in a driving simulation game a first selectable option 208 may correspond to a throttle control, and a second selectable option 210 may correspond to a brake control. If the user presses the first selectable option 208 on the control device 101 the personal visual display device 103 may highlight the portion of the interactive content 204 that corresponds to the throttle to show the user that the throttle has been properly selected. If the user tries to press the first selectable option 208 on the control device 101 but misses the exact location the personal visual display device 103 may highlight a portion of the interactive content 204 corresponding to where the user is actually touching the electronic display 202 of the control device 101 so that the user is able to correct the location of interaction on the control device 101. Similarly, if the user attempts to press the second selectable option 210 corresponding to the brake control on the control device 101, the personal visual display device 103 may highlight the portion of the interactive content 304 that corresponds to where the user is actually touching the control device 101 in relation to the control scheme 204.

The control scheme 204 may be superimposed onto the interactive content 304 according to any suitable criteria. In one embodiment, the control scheme 204 may be displayed automatically whenever the control device 101 and the personal visual display device 103 are connected over the communication network 102. Alternatively, the control scheme 204 may be superimposed onto the interactive content 304 based on predetermined events/triggers and/or manually as needed by the user. For example, the control scheme 204 may be superimposed onto the interactive content 304 whenever the user attempts to select one of the selectable options 206. In yet another embodiment, the user may be able to selectively choose whether or not the control scheme 204 is displayed on the personal visual display device 103.

The control scheme 204 may be configured to be displayed selectable degrees or levels of transparency. For example, if the control scheme 204 is only displayed on the control device 101, the control scheme 204 may be configured to be non-transparent as the control scheme 204 is the only content being displayed on the control device 101. Alternatively, when the control scheme 204 is superimposed over the interactive content 304 being displayed by the personal visual display device 103, then the control scheme 204 may be at least semi-transparent to allow simultaneous viewing of both the control scheme 204 and the interactive content 304.

The control system 108 manages control inputs from a plurality of sources and provides instructions or commands to the control device 101 and the personal visual display device 103 causing them to respond accordingly. The control system 108 may be responsive to inputs from either the control device 101 or the personal visual display device 103. The control system 108 may also manage the transfer, presentation, display, and function of the control scheme 204. The control system 108 may be configured to determine an appropriate control scheme 204 for a given type of interactive content 304. The control system 108 may then generate or otherwise communicate the control scheme 204 to the control device 101 and the personal visual display device 103 for presentation to the user. For example, in a first embodiment, the interactive content 304 maybe stored on, or accessed by the control device 101. The control system 108 may generate a control scheme 204 and instruct the control device 101 to display the control scheme 204 on the electronic display 202 of the control device 101. The control system 108 may also transmit the control scheme 204 to the personal visual display device 103 for display to the user. In a second embodiment, the interactive content 304 maybe stored on, or accessed by the personal visual display device 103 and the control system 108 may transmit the control scheme 204 to the control device 101.

Transmission of the control scheme 204 may comprise any suitable method. For example, the control system 108 may be configured to map the control scheme 204 from device to the other or the control system 108 may transmit the control scheme 204 to each device independently. The control system 108 may instruct each device how to display the control scheme 204 to provide the user with a more seamless method of interacting with the interactive content 304.

In addition to receiving control inputs from the control scheme 204, the control system 108 may be configured to receive inputs from other sources. In one embodiment, the control device 101 may be configured with an accelerometer which may be configured to provide information and/or data corresponding to the acceleration and/or orientation of the control device 101 so that the control device 101 may be utilized as a control input to the control system 108. For example, in a driving simulation game, the control device 101 may act as the steering wheel to operate the driving simulation by allowing the user to rotate the control device 101 as if the control device 101 were the steering wheel of a vehicle. This rotation may be sensed by the control system 108 as an input from the control device 101 causing the interactive 304 to respond according to the input.

The control system 108 may be responsive to voice commands. The user may speak voice commands that are received by a microphone on either the control device 101 or the personal visual display device 103. The voice commands may comprise any audio-based command corresponding to the interactive content 304. For example, in the video playback example above, the voice commands may comprise audio-based commands such as stop, rewind, fast forward, skip, and/or the like.

The control system 108 may further be responsive to physical movements and/or actions performed by the user. Physical movements may be detected by a camera disposed on the control device 101, the personal visual display device 103, or some other stand-alone device (not shown). Physical movements may comprise hand gestures, changes in body position, or any other suitable movements corresponding to a particular type of interactive content 304.

The control system 108 may be configured to generate a feedback signal in response to receiving one or more inputs or in response to the interactive content 304 itself. The control system 108 may be configured to provide feedback signals in any suitable format such as audio, visual, and/or physical. The feedback signal may be presented to the user in any suitable format to the control device 101 and/or the personal visual display device 103.

In one embodiment, the feedback signal may be displayed to the user via the personal visual display device 103. For example, if the control system 108 is utilized to play an interactive video game, the user may be required to provide various control inputs to the control device 101 to interact with the interactive content 304 that is being displayed by the personal visual display device 103. When the user provides a control input to the control device 101 via the control scheme 204, the particular control input may be displayed to the user via the interactive display 302 of the personal visual display device 103. Alternatively, the control system 108 may be configured to present movement along the electronic display 202 of the control device 101. For example, if the user presses the electronic display 202 of the control device 101 an echo, or representation, of that touch may be displayed on the personal visual display device 103 with respect to the control scheme 204. Then, if the user slides their finger along the electronic display 202 of the control device 101 that movement may be displayed to the user so that the user may be better able to coordinate touch inputs on the electronic display 202 of the control device 101 with the representation of the control scheme 204 being shown on the personal visual display device 103.

In one embodiment, the feedback signal may comprise an audio alert provided to the user. For example, when the control device 101 receives an input via the control scheme 204, the control device 101 may be instructed to produce an audio alert to notify the user that an input has been received. The audio alert may comprise any suitable audio alert such as bells, rings, buzzers, and/or the like. The audio alert may be predetermined and/or customized by the user.

The feedback signal may comprise tactile feedback and/or vibrations. For example, when the user provides an input to the control device 101 via the control scheme 204, the control device 101 may be configured to provide tactile feedback to the user to indicate that their input was received. Attributes of the tactile feedback such as duration and/or intensity may be determined by the interactive content 304, the user, the control device 101, and/or the personal visual display device 103.

The control system 108 may further be configured to allow the user to interact with the interactive content 304 without requiring the user to press in the exact location of a given selectable input 206 on the control device 101. For example, in one embodiment, the control system 108 may be configured to identify a particular spot or zone within the control scheme layout and associate that zone with a particular selectable option 206. The control system 108 may then accept any input within that zone as corresponding to the selectable option 206 associated with that zone. The size of the zone may be adjusted or moved based on the user's preference.

In one embodiment, the control system 108 may be configured to calibrate the control scheme according to a given user or allow the user to customize a layout of the control scheme 204. In one embodiment, the control system 108 may present the user with a calibration program that is able to scale the control scheme 204 on the control device 101. For example, the control system 108 may initiate a calibration sequence by prompting a user to hold the control device 101 as they would during use and then running the user through a series of steps or movements designed to ascertain the user's ability to perform certain functions on the control device 101 or determine how much the of the electronic display 202 can access/reach while holding the control device 101. The control system 108 may sense the user's responses and store the responses as a set or create a heat map based on the user's responses. The control system 108 may then use set of responses or the heat map to adjust or otherwise scale the control scheme on the control device 101 accordingly.

The control system 108 may further be configured to interpret certain user inputs that may not directly correspond to the control scheme 204 as being a proper input to allow a more seamless experience with the interactive content 304. In one embodiment, the control system 108 may be configured to interpret a user's intent to interact with the control scheme 204 on the control device 101 by sensing relative movement of the user's fingers on the electronic display 202 of the control device 101 in relation to the control scheme 204. For example, if a first selectable option 206 is directly below a second selectable option 206, the control system 108 may perceive any movement of the user's finger in a generally upward direction from the first selectable option 206 as being directed to the second selectable option 206 even if the actual movement of the user's finger was not in perfect alignment of the control scheme 204.

The control system 108 may also be configured to store the user's inputs to the control scheme 204 over time. For example, a particular control scheme layout may be utilized whenever the user watches a video on the visual display device 103. The particular control scheme layout may comprise several selectable options 206 disposed at various locations/positions of the control scheme 204. For example, the selectable option for “play” may be disposed in the bottom-left corner of the electronic display 202 of the control device 101. Because the user is unable to view the electronic display 202 of the control device 101 when the user is wearing the personal visual display device 103, it can be the case that the user activates/selects the particular selectable option by pressing a different location on the control scheme 204, but still within an acceptable range or zone of the selectable option for “play.” Thus, the control scheme 204 may be configured create a heat map to store/remember a historical preference of where the user prefers to activate a particular selectable option and adjust the control scheme 204 to match that preference.

The control system 108 may be configured to trace a user's input across the electronic display 202 of the control device 101. For example, a particular application may request that the user place a finger on the electronic display 202 of the control device 101, however, since the user may be unable to view electronic display 202 when wearing the personal visual display device 103, the control system 108 may be configured to display on interactive display screen 302 of the personal visual display device 103 a visual indication of the user's finger position on the electronic display 202 as well as tracking the finger's movement as it moves across the electronic display 202.

The control system 108 may further be configured to provide a visual indication of the physical orientation of the control device 101 on the personal visual display device 103. The physical orientation may comprise any suitable information and/or data regarding the physical orientation (state) of the control device 101. Changes, adjustments, modifications, and the like to the control device 101 may be reflected by indicating the change to the user. For example, if the user is utilizing the personal visual display device 103 to play an interactive driving simulation game wherein the control device 101 operates as the steering wheel for the game, the personal visual display device 103 may be configured to display to the user changes in the physical orientation of the control device 101 such as when the user turns and/or rotates the control device 101 as one typically would for a steering wheel.

The control system 108 may further be configured to provide an initial game play environment on the control device 101 to allow the user to become familiar with the control scheme 204 or how to control the interactive content 304. In one embodiment, the control system 108 may present the interactive content 304 to the user on the control device 101 and allow the user to interact with the interactive content 304 in a manner similar to a standard video game environment. For example, the controls and/or control scheme 204 for the interactive content 304 may be presented to the user on the control device 101 along with the interactive content 304. The user may then play with or interact with the interactive content 304 on the control device 101 by using the controls and/or control scheme 204. After some time, the user may begin using the personal visual display device 103 to interact with the interactive content 304. Since the user is already familiar with how to control the interactive content 304, the user's transition to a VR or AR environment may be easier since the user is already familiar with how to use the controls on the control device 101.

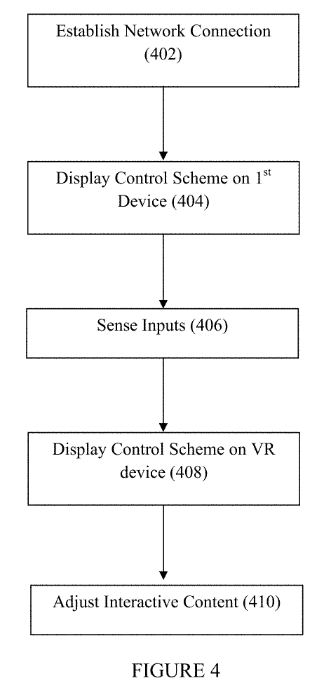

Now referring to FIG. 4, in operation in response to a command from the user wanting to view the interactive content 109, the display system 100 may establish a communication network 102 connection between the control device 101 and the personal visual display device 103 (402). The communication network 102 may comprise any suitable system configured to establish a wireless communication channel between the control device 101 and the personal visual display device 103. The communication network 102 may further comprise a wireless communication channel between the control device 101 and the personal visual display device 103 and plurality of additional systems. For example, the communication network 102 may comprise a communication channel between the control device 101, the personal visual display device 103, and at least one additional device such as a PC, tablet, laptop, TV, smartphones, and/or the like. In some instances, the communication network 102 and/or the communication channel may comprise wired connections.

The control scheme 204 may be selectively displayed on the control device 101 (404) according to any suitable criteria such as the interactive content 304 itself or the types of devices connected over the communication network 102. The particular layout of the control scheme 204, including which selectable options 206 are available to the user, may be determined by either the control system 108, the control device 101, the personal visual display device 103, or the interactive content 304. For example, an application associated with the interactive content 304 may be loaded onto the control device 101 and communicated to the control system 108 so that an appropriate control scheme 204 may be displayed on both the control device 101 and the personal visual display device 103. Alternatively, the application may be loaded onto the personal visual display device 103 and processed accordingly so that the appropriate control scheme 204 may be transmitted over the communication network 102 to the control device 101 where the control scheme 204 may be presented to the user accordingly.

As the user interacts with the interactive content 304, the control device 101 may sense/receive control inputs from the user (406). For example, the user may provide inputs to the control scheme 204 by touching the electronic display 202 or otherwise manipulating the control device 101.

The control scheme 108 may also be displayed on the interactive display screen 302 personal visual display device 103 (408) as the user is interacting with the interactive content 304. For example, the display system 100 may be configured to superimpose at least a portion of the control scheme 204 onto the interactive content 304. As discussed above, the control scheme 204 may be configured to be displayed alongside, on top of, or in conjunction with the interactive content 304 that is displayed on the interactive display screen 302 of the personal visual display device 103 in a way that allows the user to relate where to properly supply inputs to the control device 101 without taking away from the immersion of the interactive content 304 by causing the user to have to physically look at the electronic display 202 of the control device 101.

The interactive content 304 displayed on the interactive display screen 302 of the personal visual display device 103 may be adjusted according to the inputs received via the control device 101 (410). For example, if the user provides an input corresponding to a selectable option 206, the particular selectable option may be activated and the interactive content 304 responds accordingly. In this manner, the user is able to better control the VR experience with a separate controller such as a mobile phone without having to remove the headset.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A computer-implemented method for allowing a user to use a control device to interact with interactive content displayed on an interactive display screen of a personal visual display device, comprising:
establishing a communication network between the control device and the personal visual display device;
generating a control scheme based on the interactive content;
configuring the control device to receive user control inputs corresponding to the control scheme;
superimposing at least a portion of the control scheme over the interactive content on the interactive display screen of the personal visual display device, wherein the superimposed portion of the control scheme communicates a layout of the control scheme on the control device;
sensing the user control inputs with the control device;
providing a visual indication on the personal visual display device of where the sensed user control inputs actually occurred on the control device relative to the control scheme; and
communicating the sensed control inputs from the control device to a control system, wherein the control system is configured to adjust the interactive content according to the sensed user control inputs.

2. The method of claim 1, wherein the control scheme comprises a plurality of selectable options.

3. The method of claim 2, further comprising:
storing, by the control device, a history of where the user activates a particular selectable option from the plurality of selectable options; and
constructing, by the control device, a heat map configured to represent the user's preference of where the particular selectable option is activated.

4. The method of claim 3, wherein each selectable option is associated with a zone within the control scheme.

5. The method of claim 4, wherein the zones are displayed on the personal visual display according to the heat map.

6. The method of claim 1, wherein the sensed user control inputs further comprises at least one of: a physical manipulation of the control device, a physical movement performed by the user, and a voice command.

7. The method of claim 1, wherein superimposing at least a portion of the control scheme comprises mapping a plurality of selectable options of the control scheme to the interactive display screen of the personal visual display device.

8. The method of claim 1, further comprising providing the user a visual indication of an orientation of the control device on the interactive display screen of the personal visual display device.

9. The method of claim 1, further comprising scaling the control scheme on the control device according to a set of user responses to a calibration sequence.

10. A computer-implemented method for selectively displaying a control scheme on a control device having a first electronic display and on a personal display device configured to display an interactive content, comprising:
establishing a wireless communication link between the control device and the personal display device;
selectively displaying the control scheme on at least one of the first electronic display and the personal display device, wherein the control scheme represents a plurality of selectable options associated with the interactive content;
receiving by the first electronic display of the control device a control input corresponding to the displayed control scheme;
providing a visual indication on the personal display device of where the received control input actually occurred on the first electronic display relative to the displayed control scheme; and
adjusting the interactive content displayed on the personal display device according to the received inputs.

11. The method of claim 10, wherein the control scheme is presented as a physical layout of the plurality of selectable options.

12. The method of claim 11, further comprising:
storing a history of where a user activates a particular selectable option within the control system scheme; and
constructing a heat map configured to represent the user's preference on where a particular selectable option is activated.

13. The method of claim 11, wherein each selectable option is associated with a zone within the control scheme.

14. The method of claim 13, wherein the zones are displayed on the personal display device according to the heat map.

15. The method of claim 12, wherein the receiving the control input further comprises at least one of: a physical manipulation of the control device, a physical movement performed by a user, and a voice command.

16. The method of claim 10, wherein selectively displaying the control scheme comprises superimposing at least a portion of the control scheme over the interactive content on the personal visual display device.

17. The method of claim 16, wherein superimposing at least a portion of the control scheme comprises mapping a plurality of selectable options to the personal display device.

18. The method of claim 10, further comprising providing a visual indication of an orientation of the control device on the personal visual display device.

19. The method of claim 10, further comprising scaling the control scheme on the control device according to a set of user responses to a calibration sequence.
